(19) United States
(12) Patent Application Publication
(10) Pub. No.: US 2011/0176691 A1
(43) Pub. Date: Jul. 21, 2011

(54) SOUND CONTROL APPARATUS, SOUND CONTROL METHOD, AND SOUND CONTROL PROGRAM

(75) Inventor: Yukishige Yoshitomi, Kizugawa City (JP)

(73) Assignee: SANYO ELECTRIC CO., LTD., Osaka (JP)

(21) Appl. No.: 13/010,393

(22) Filed: Jan. 20, 2011

(30) Foreign Application Priority Data
Jan. 21, 2010 (JP) 2010-011265

(51) Int. Cl. H04R 3/00

(52) U.S. Cl. 381/92

(57) ABSTRACT

A sound control apparatus includes a direction accepting portion to accept designation of any one of a plurality of predetermined directions, a display control portion to allow a display portion to output a plurality of direction marks respectively indicating the plurality of directions, a plurality of microphones arranged at a distance away from each other, and a directivity control portion to control directivity of sounds respectively obtained by the plurality of microphones. The display control portion allows the display portion to display a direction mark corresponding to the direction accepted by the direction accepting portion in such a manner as to be enhanced as compared with any other direction mark.

This application is based on Japanese Patent Application No. 2010-011265 filed with Japan Patent Office on Jan. 21, 2010, the entire content of which is hereby incorporated by reference.

### BACKGROUND OF THE INVENTION

1. Field of the Invention

The present invention relates to a sound control apparatus suitable for recording or reproducing sounds emitted from a plurality of sound sources.

2. Description of the Related Art

There exists a known technique that collects sounds coming from a plurality of directions and reproduces a sound coming from a particular direction based on the collected sounds coming from a plurality of directions.

### SUMMARY OF THE INVENTION

In accordance with an aspect of the present invention, a sound control apparatus includes: a direction accepting portion to accept designation of any one of a plurality of predetermined directions; a display control portion to allow a display portion to output a plurality of direction marks respectively indicating the plurality of directions; a plurality of microphones arranged at a distance away from each other; and a directivity control portion to control directivity of sounds respectively obtained by the plurality of microphones, based on the direction accepted by the direction accepting portion. The display control portion allows the display portion to display a direction mark corresponding to the direction accepted by the direction accepting portion in such a manner as to be enhanced as compared with any other direction mark.

In accordance with another aspect of the present invention, a sound control method is executed in a sound control apparatus including a plurality of microphones arranged at a distance away from each other and a display portion. The method includes: an accepting step of accepting designation of any one of a plurality of predetermined directions; a display control step of allowing the display portion to output a plurality of direction marks respectively indicating the plurality of directions; and a directivity control step of controlling directivity of sounds respectively obtained by the plurality of microphones, based on the direction accepted in the accepting step. The display control step includes a step of allowing the display portion to display a direction mark corresponding to the direction accepted in the accepting step in such a manner as to be enhanced as compared with any other direction mark.

In accordance with a further aspect of the present invention, a non-transitory computer-readable recording medium is encoded with a sound control program. The sound control program causes a computer that controls a sound control apparatus including a plurality of microphones arranged at a distance away from each other and a display portion to execute: an accepting step of accepting designation of any one of a plurality of predetermined directions; a display control step of allowing the display portion to output a plurality of direction marks respectively indicating the plurality of directions; and a directivity control step of controlling directivity of sounds respectively obtained by the plurality of microphones, based on the direction accepted in the accepting step. The display control step includes a step of allowing the display portion to display a direction mark corresponding to the direction accepted in the accepting step in such a manner as to be enhanced as compared with any other direction mark.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of an IC recorder.

FIG. 2 is a block diagram showing an overall hardware configuration of the IC recorder.

FIG. 3 is a block diagram showing an example of functions of a CPU.

FIG. 4 illustrates ranges of directions.

FIG. 5 shows an example of a non-direction image.

FIG. 6 shows an example of a left direction image.

FIG. 7 shows an example of a central direction image.

FIG. 8 shows an example of a right direction image.

FIG. 9 is an internal block diagram of a signal separation portion.

FIG. 10 illustrates a positional relation between a sound source, a right directional microphone, and a left directional microphone.

FIG. 11 illustrates areas in a two-dimensional plane.

FIG. 12 is a block diagram showing an exemplary configuration of a sound source separation portion in detail.

FIG. 13 illustrates areas in a two-dimensional plane and directions of sound sources.

FIG. 14 shows an example of sound sources and their directions.

### DESCRIPTION OF THE PREFERRED EMBODIMENTS

The preferred embodiments of the present invention will be described below in conjunction with the drawings. In the following description, the same or corresponding parts are denoted by the same reference characters. Their names and functions are also the same. Thus, a detailed description thereof will not be repeated.

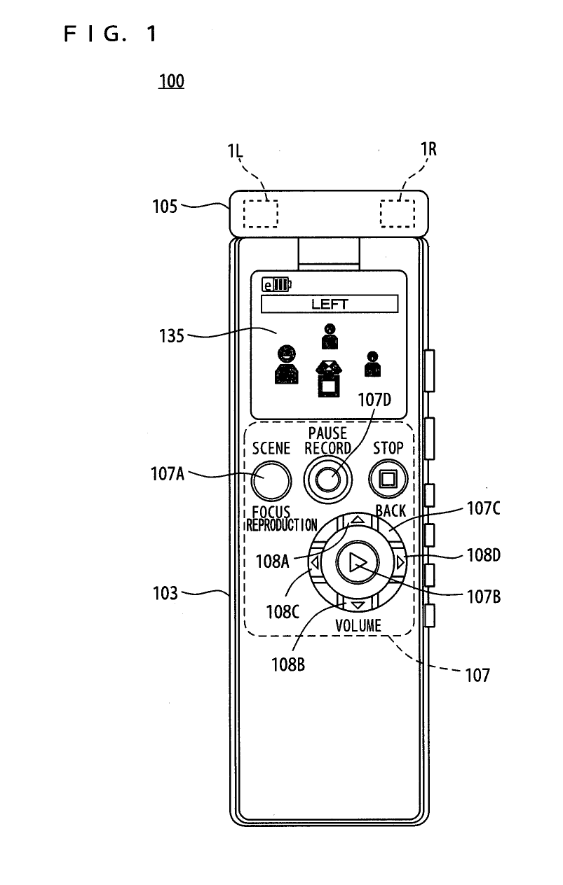

FIG. 1 is a plan view of an IC recorder. Referring to FIG. 1, an IC recorder 100 includes a body unit 103 and a sound collecting unit 105 containing a right directional microphone 1R and a left directional microphone 1L.

Body unit 103 includes a liquid crystal display (LCD) 135 and an operation portion 107, provided below LCD 135, having different kinds of buttons. Operation portion 107 includes a focus reproduction mode switch button 107A for accepting an operation of selecting a focus reproduction mode, a replay button 107B for accepting an operation of replaying a recorded sound, a cross key 107C, and a record button 107D for accepting an operation of recording a sound. Focus reproduction mode switch button 107A, replay button 107B, and record button 107D are hard keys and have contact switches. Cross key 107C has up, down, left, and right buttons 108A, 108B, 108C, and 108D respectively on the top, bottom, left and right thereof to accept an operation of designating a direction. LCD 135 may be replaced by any other display, for example, an organic ELD (Electro Luminescence Display).

Right directional microphone 1R and left directional microphone 1L are arranged at a prescribed distance away from each other. Although right directional microphone 1R and left directional microphone 1L having directivity are illustrated here by way of example, non-directional microphones may be arranged at a prescribed distance away from each other. Although IC recorder 100 having two microphones, namely, right directional microphone 1R and left directional microphone 1L is illustrated by way of example, the number of microphones is not limited as long as two or more are provided.

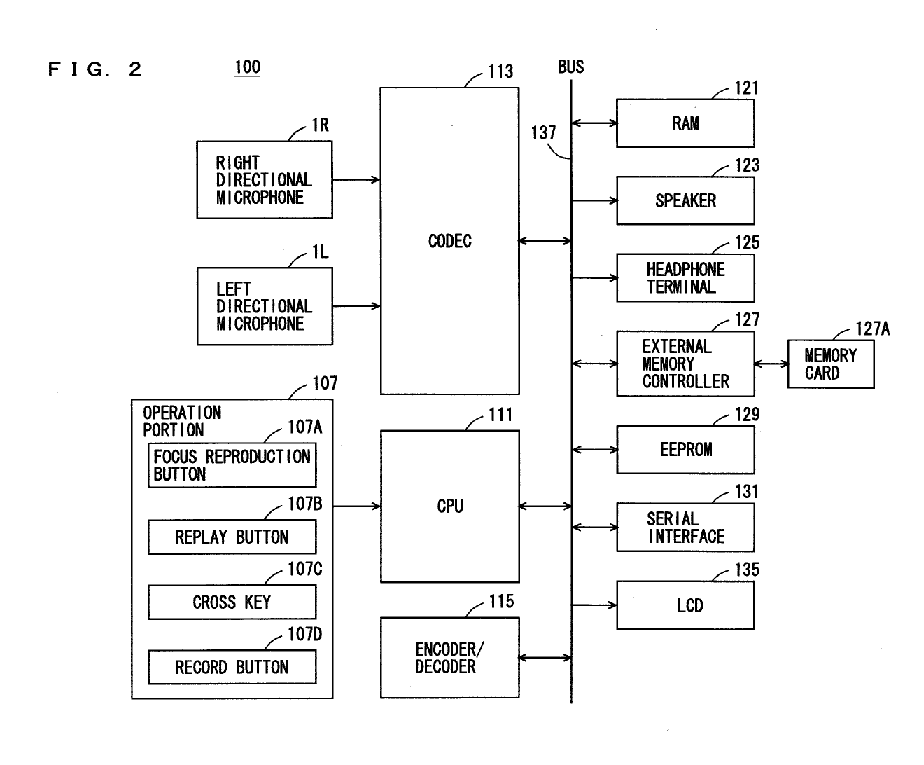

FIG. 2 is a block diagram showing an overall hardware configuration of the IC recorder. Referring to FIG. 2, IC recorder 100 includes a CPU (Central Processing Unit) 111 for controlling the entire IC recorder 100, and a codec 113, an encoder/decoder 115, a RAM (Random Access Memory) 121, a speaker 123, a headphone terminal 125, an external memory controller 127, an EEPROM (Electrically Erasable and Programmable Read Only Memory) 129, a serial interface (I/F) 131, and LCD 135, each connected to CPU 111 through a bus 137. Although EEPROM 129 is used here, any other semiconductor memory may be used as long as it is a nonvolatile memory.

CPU 111 is connected to operation portion 107 to accept an operation input by the user to operation portion 107. Operation portion 107 includes focus reproduction mode switch button 107A, replay button 107B, cross key 107C, and record button 107D. When the user presses record button 107D, operation portion 107 detects that record button 107D has been pressed, and outputs a recording instruction to CPU 111. Upon receiving the recording instruction, CPU 111 stores sounds respectively collected by right directional microphone 1R and left directional microphone 1L into EEPROM 129. When the user presses replay button 107B, operation portion 107 detects that replay button 107B has been pressed, and outputs a reproduction instruction to CPU 111. Upon receiving the reproduction instruction, CPU 111 reproduces the sound stored in EEPROM 129. When the user presses focus reproduction mode switch button 107A, operation portion 107 detects that focus reproduction mode switch button 107A has been pressed, and outputs a focus reproduction mode switch instruction to CPU 111. Upon receiving the focus reproduction mode switch instruction, CPU 111 switches the reproduction mode to the focus reproduction mode. The focus reproduction mode is a mode in which a sound is generated by enhancing a sound coming from a direction designated by the user as compared with sounds coming from other directions whereby a sound having controlled sound directivity is output.

When up button 108A of cross key 107C is pressed, operation portion 107 detects that up button 108A has been pressed, and outputs a signal indicating the central direction to CPU 111. When down button 108B is pressed, operation portion 107 detects that down button 108B has been pressed, and outputs a non-direction signal indicating no direction to CPU 111. When left button 108C is pressed, operation portion 107 detects that left button 108C has been pressed, and outputs a signal indicating the left direction to CPU 111. When right button 108D is pressed, operation portion 107 detects that right button 108D has been pressed, and outputs a signal indicating the right direction to CPU 111. When receiving the signal indicating the central direction, CPU 111 detects that the central direction is designated by the user. When receiving the signal indicating non-direction, CPU 111 detects that non-direction is designated by the user. When receiving the signal indicating the left direction, CPU 111 detects that the left direction is designated by the user. When receiving the signal indicating the right direction, CPU 111 detects that the right direction is designated by the user.

RAM 121 is used as a work area for CPU 111. EEPROM 129 stores, for example, a program executed by CPU 111. EEPROM 129 is an internal memory for storing a compressed audio signal and the like in a nonvolatile manner. A memory card 127A is connected to external memory controller 127. CPU 111 can access memory card 127A connected to external memory controller 127 through external memory controller 127.

A device capable of serial communication is connected to serial interface 131. CPU 111 can communicate with a device connected to serial interface 131 through serial interface 131. A headphone or an earphone is connected to headphone terminal 125. Headphone terminal 125 outputs an analog audio signal to the connected headphone or earphone. Speaker 123 receives an analog audio signal and outputs a sound.

Codec 113 is connected with right directional microphone 1R and left directional microphone 1L to convert analog audio signals respectively input from right directional microphone 1R and left directional microphone 1L into digital signals, which are in turn subjected to prescribed signal processing. The digitized audio signals are then output to CPU 111.

Encoder/decoder 115 is controlled by CPU 111 to encode an audio signal output from codec 113. Encoder/decoder 115 is also controlled by CPU 111 to decode the encoded audio signal.

The audio signal output from right directional microphone 1R or left directional microphone 1L is converted into a digital signal by codec 113. CPU 111 allows encoder/decoder 115 to encode the audio signal output by codec 113 and stores the encoded audio signal into EEPROM 129 or memory card 127A connected to external memory controller 127. When, for example, an external storage device including a flash memory is connected as a device capable of serial communication to serial interface 131, CPU 111 can access the external storage device to store the audio signal in the external storage device.

CPU 111 reads the audio signal stored in EEPROM 129 or memory card 127A. When, for example, an external storage device including a flash memory is connected to serial interface 131, CPU 111 accesses the external storage device to read the audio signal stored in the external storage device. CPU 111 allows encoder/decoder 115 to decode the read audio signal, allows codec 113 to convert the decoded audio signal into an analog signal, and outputs the analog audio signal to speaker 123 or the headphone connected to headphone terminal 125.

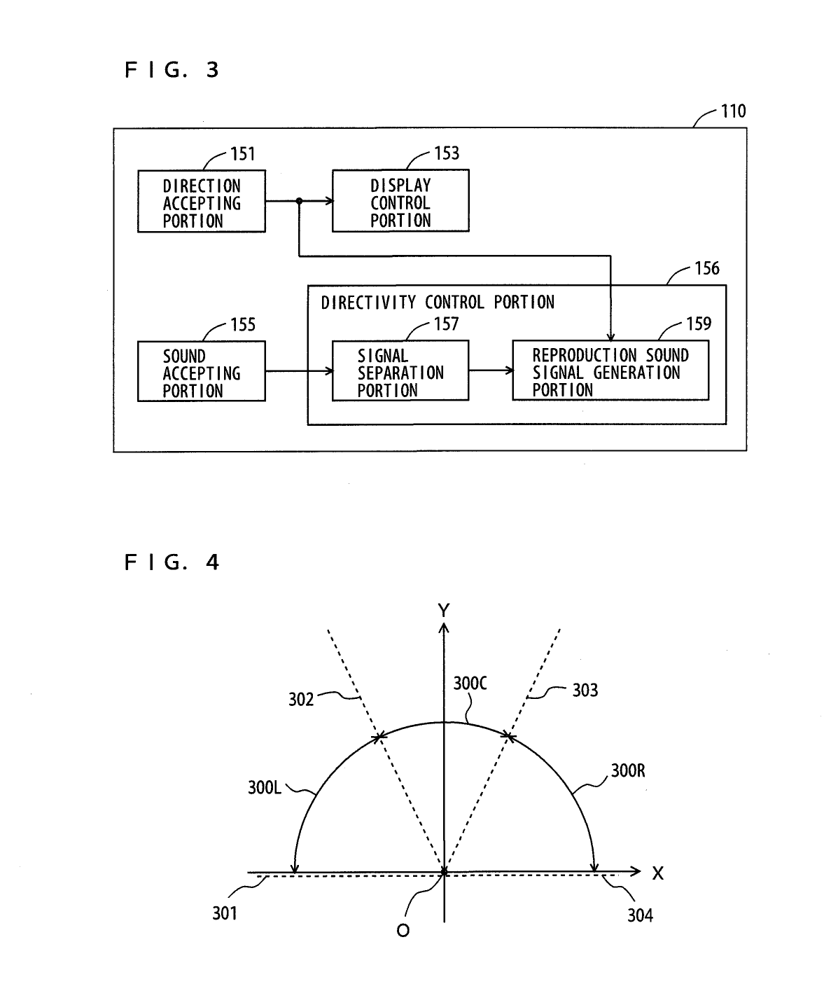

FIG. 3 is a block diagram showing an example of functions of CPU. CPU 111 includes a direction accepting portion 151 for accepting a direction, a display control portion 153 for displaying the accepted direction, a sound accepting portion 155 for accepting a sound, and a directivity control portion 156 for controlling directivity of a sound.

Direction accepting portion 151 is connected with cross key 107C to receive any one of the central direction, the non-direction, the right direction, and the left direction. Direction accepting portion 151 outputs the accepted direction to display control portion 153 and directivity control portion 159. The directions to be accepted by direction accepting portion 151 include three directions, namely, the central direction, the right direction, and the left direction, as well as the non-direction which does not represent any direction. Here, the central direction, the right direction, and the left direction each have a prescribed range.

FIG. 4 illustrates ranges of directions. Referring to FIG. 4, in an XY coordinate plane in which IC recorder 100 is placed at origin O, three areas 300L, 300C, and 300R are defined by lines 301-304 as boundaries. The relation between each of lines 301-304 and the X-axis and the Y-axis can be changed, for example, by a user's instruction. Unless not being changed, line 301 is a line extending parallel to the X-axis from origin O toward the negative direction of the X-axis, line 304 is a line extending parallel to the X-axis from origin O toward the positive direction of the X-axis, line 302 is a line extending from origin O toward the second quadrant on the XY coordinate plane, and line 303 is a line extending from origin O toward the first quadrant on the XY coordinate plane. In this case, lines 301 and 304 lie on the X-axis, although lines 301 and 304 shown in FIG. 4 are slightly shifted from the X-axis for the sake of illustration. For example, line 302 is inclined by 30 degrees counterclockwise with respect to the Y-axis, and line 303 is inclined by 30 degrees clockwise with respect to the Y-axis.

Area 300L is a partial area of the second quadrant of the XY coordinate plane that is sandwiched between lines 301 and 302. Area 300C is a partial area of the first and second quadrants of the XY coordinate plane that is sandwiched between lines 302 and 303. Area 300R is a partial area of the first quadrant of the XY coordinate plane that is sandwiched between lines 303 and 304. Here, area 300C is associated with the central direction, area 300L is associated with the left direction, and area 300R is associated with the right direction. In other words, the central direction covers the range from the front of the IC recorder 100 to the right and to the left by 30 degrees each, the right direction covers the range from the right end of the central direction to the right side by 60 degrees, and the left direction covers the range from the left end of the central direction to the left side by 60 degrees. The direction of the front of IC recorder 100 depends on right directional microphone 1R and left directional microphone 1L and here is set as the intermediate direction between the directional direction of right directional microphone 1R and the directional direction of left directional microphone 1L.

Returning to FIG. 3, display control portion 153 outputs to a display an image indicating the direction accepted by direction accepting portion 151, when the focus reproduction mode is switched on. Here, display control portion 153 displays an image indicating the direction accepted by direction accepting portion 151, on LCD 135 as the display. If the right direction is accepted, a right direction image indicating the right direction appears on LCD 135. If the left direction is accepted, a left direction image indicating the left direction appears on LCD 135. If the central direction is accepted, a central direction image indicating the central direction appears on LCD 135. If non-direction is accepted, a non-direction image indicating no direction appears on LCD 135.

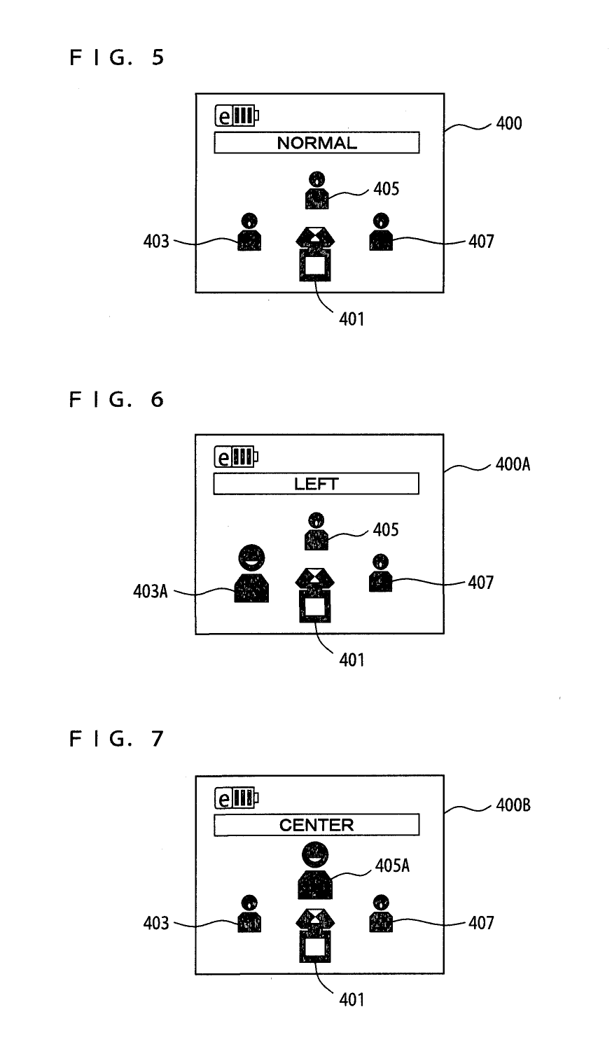

FIG. 5 shows an example of the non-direction image. Referring to FIG. 5, a non-direction image 400 includes a region represented by “NORMAL,” an image 401 depicting IC recorder 100, and direction marks 403, 405, 407. The direction mark is an image depicting a person and is referred to as “Character” hereinafter. The direction mark may be a character (letter), symbol, mark, or sign. Characters 403, 405, 407 have the same shape and size. Characters 403, 405, 407 are arranged in this order from the left. Character 401 is displayed at the lower middle portion of non-direction image 400. Character 403 is arranged to the left of Character 401. Character 405 is arranged at the upper middle portion of non-direction image 400. Character 407 is arranged to the right of Character 401. Character 405 is arranged above Character 401. The relative position of three Characters 403, 405, 407 is set similar to the relative position of up button 108A, left button 108C, and right button 108D of cross key 107C. This allows the user to intuitively understand that Character 405 corresponds to up button 108A, Character 403 corresponds to left button 108C, and Character 407 corresponds to right button 108D.

FIG. 6 shows an example of the left direction image. A left direction image 400A includes a region represented by “LEFT,” image 401 depicting IC recorder 100, and Characters 403A, 405, 407. When compared with non-direction image 400 shown in FIG. 5, Character 403A has the same shape as character 403 but is larger in size than Character 403. Left direction image 400A displays when the left direction is accepted by direction accepting portion 151. In left direction image 400A, Character 403A corresponding to the left direction accepted by direction accepting portion 151 is enhanced as compared with Characters 405, 407 corresponding to the other, central and right directions, respectively. Since Character 403A is arranged to the left of Character 401, the user can know that the left direction, which is to the left of IC recorder 100, is selected, and can visually grasp the direction designated by the user in an intuitive manner.

FIG. 7 shows an example of the central direction image. A central direction image 400B includes a region represented by “CENTER,” image 401 depicting IC recorder 100, and Characters 403, 405A, 407. When compared with non-direction image 400 shown in FIG. 5, Character 405A has the same shape as character 405 but is larger in size than Character 405. Central-direction image 400B displays when the central direction is accepted by direction accepting portion 151. In central direction image 400B, Character 405A corresponding to the central direction accepted by direction accepting portion 151 is enhanced as compared with Characters 403, 407 corresponding to the other, left and right directions, respectively. Since Character 405A is arranged in the center, similarly to Character 401, the user can know that the forward direction of IC recorder 100 is selected, and can visually grasp the direction specified by the user in an intuitive manner.

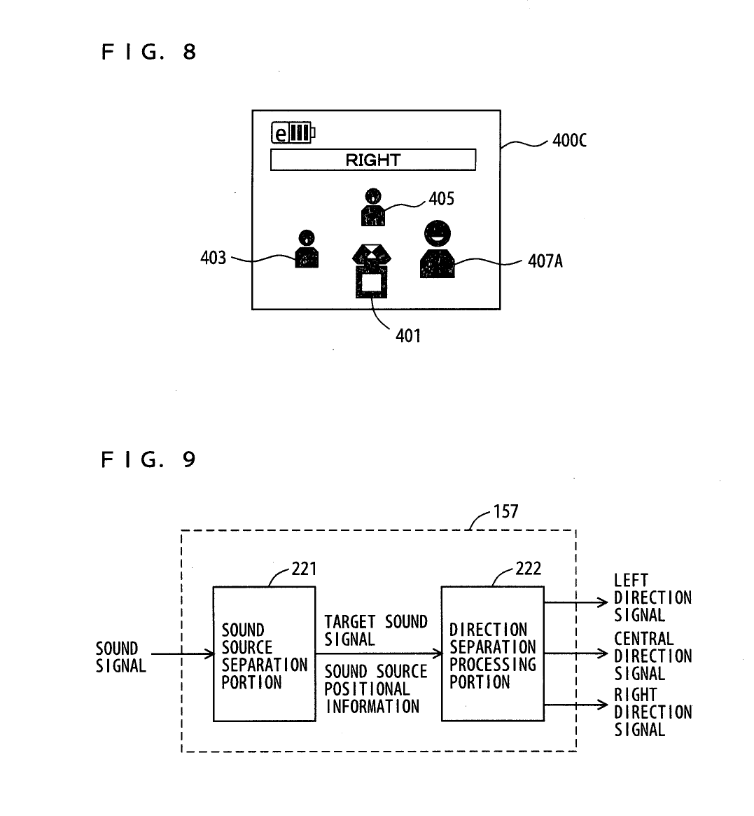

FIG. 8 shows an example of the right direction image. A right direction image 400C includes a region represented by “RIGHT,” image 401 depicting IC recorder 100, and Characters 403, 405, 407A. When compared with non-direction image 400 shown in FIG. 5, Character 407A has the same shape as character 407 but is larger in size than Character 407. Right direction image 400C displays when the right direction is accepted by direction accepting portion 151. In right direction image 400C, Character 407A corresponding to the right direction accepted by direction accepting portion 151 is enhanced as compared with Characters 403, 405 corresponding to the other, left and central directions, respectively. Since Character 407A is arranged to the right of Character 401, the user can know that the right direction, which is to the right of IC recorder 100, is selected, and can visually grasp the direction specified by the user in an intuitive manner.

Returning to FIG. 3, sound accepting portion 155 is connected with right directional microphone 1R and left directional microphone 1L to output sound signals from right directional microphone 1R and left directional microphone 1L to directivity control portion 156.

Directivity control portion 156 controls sound directivity based on the sound signals input from sound accepting portion 155. Through the control of sound directivity, the input sounds are changed in such a manner that a sound included in the input sounds and coming from any given direction is enhanced as compared with sounds coming from other directions. Directivity control portion 156 includes a signal separation portion 157 for separating the sound signals input from sound accepting portion 155 on a direction-by-direction basis of sound source, and a reproduction sound signal generation portion 159 for generating a sound in such a manner that a selected sound from among the sounds separated direction by direction is enhanced as compared with any other sound. When the focus reproduction mode is switched on, signal separation portion 157 separates two sound signals input from sound accepting portion 155 into three signals, namely, a central direction signal, a right direction signal, and a left direction signal, and outputs the central direction signal, the right direction signal, and the left direction signal to reproduction sound signal generation portion 159.

Reproduction sound signal generation portion 159 receives the central direction signal, the right direction signal, and the left direction signal from the signal separation portion 157 and receives a direction from direction accepting portion 151. When the focus reproduction mode is switched on, reproduction sound signal generation portion 159 generates a reproduction sound signal in which, of the central direction signal, the right direction signal and the left direction signal, the signal of the same direction as the direction input from direction accepting portion 151 is enhanced as compared with the other signals. Reproduction sound signal generation portion 159 outputs the generated reproduction sound signal to speaker 123 or the headphone terminal. Therefore, with a simple operation of designating a direction, the user can hear a sound produced by enhancing the sound from the desired direction as compared with that from any other direction.

Specifically, when the central direction is input from direction accepting portion 151, only the central direction signal is selected from among the central direction signal, the left direction signal, and the right direction signal, and the central direction signal is generated as a reproduction sound signal. When the left direction is input from direction accepting portion 151, only the left direction signal is selected from among the central direction signal, the left direction signal, and the right direction signal, and the left direction signal is generated as a reproduction sound signal. When the right direction is input from direction accepting portion 151, only the right direction signal is selected from among the central direction signal, the left direction signal, and the right direction signal, and the right direction signal is generated as a reproduction sound signal.

Alternatively, reproduction sound signal generation portion 159 may enhance or attenuate the central direction signal, the right direction signal, and the left direction signal to generate a reproduction sound signal in which the sound from the direction input from direction accepting portion 151 is enhanced. For example, when the user designates the central direction and the central direction is input from direction accepting portion 151, a reproduction sound signal is generated by amplifying the central direction signal, attenuating the sounds of the right direction signal and the left direction signal, and synthesizing these signals. The amplification of the central direction signal means that the signal level of the central direction signal is increased. The attenuation of the right direction signal and the left direction signal means that the signal level of the right direction signal and the left direction signal is attenuated. As a matter of course, when the central direction signal is amplified, the signal component of the central direction is enhanced. When the right direction signal and the left direction signal are attenuated, the signal components of the right direction signal and the left direction signal are attenuated. On the other hand, when the user designates the right direction and the right direction is input from direction accepting portion 151, a reproduction sound signal is generated by amplifying the right direction signal, attenuating the sounds of the central direction signal and the left direction signal, and synthesizing these signals. When the user designates the left direction and the left direction is input from direction accepting portion 151, a reproduction sound signal is generated by amplifying the left direction signal, attenuating the sounds of the central direction signal and the right direction signal, and synthesizing these signals.

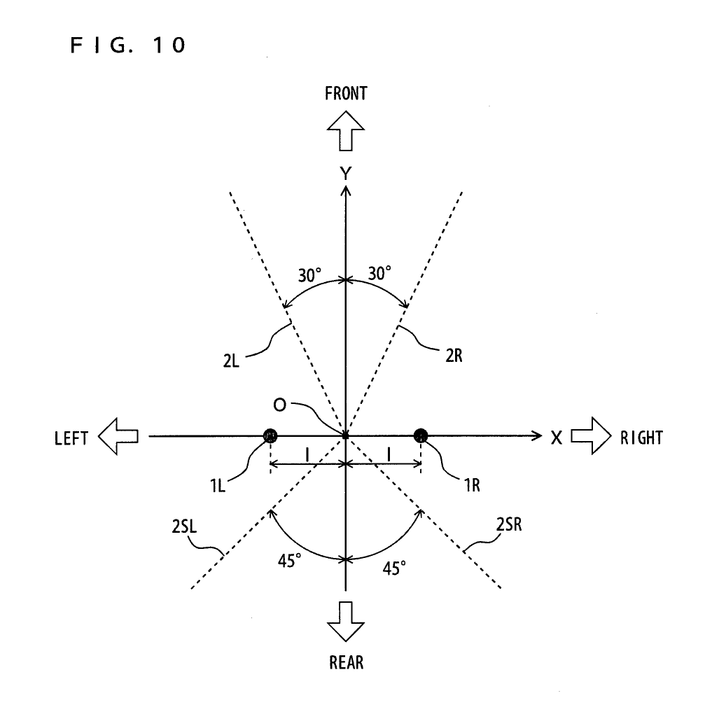

Signal separation portion 157 will now be described in detail. FIG. 9 is an internal block diagram of the signal separation portion. Signal separation portion 157 includes a sound source separation portion 221 and a direction separation processing portion 222. Sound source separation portion 221 receives sound signals input from right directional microphone 1R and left directional microphone 1L to output a sound signal generated by separating and extracting a signal from a sound source from the input sound signals.

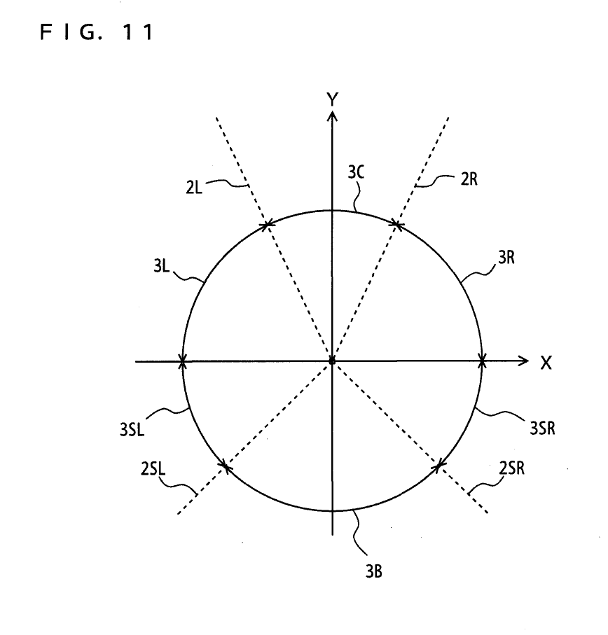

FIG. 10 illustrates the positional relation between a sound source, the right directional microphone, and the left directional microphone. FIG. 10 shows a two-dimensional coordinate plane having, as coordinate axes, the X-axis and the Y-axis orthogonal to each other. The X-axis is orthogonal to the Y-axis at origin O. With origin O as a reference point, the positive direction of the X-axis is the right side (right direction), the negative direction of the X-axis is the left side (left direction), the positive direction of the Y-axis is the front side (central direction), and the negative direction of the Y-axis is the rear side. The positive direction of the Y-axis is the direction in which a main sound source should be present.

Right directional microphone 1R and left directional microphone 1L are arranged at respective different locations on the X-axis. Left directional microphone 1L is arranged at a distance I from origin O toward the left side, and right directional microphone 1R is arranged at a distance I from origin O toward the right side. Distance I is, for example, a few centimeters. Furthermore, four lines extending from origin O toward the first, second, third, and fourth quadrants on the XY coordinate plane are referred to as 2R, 2L, 2SL, and 2SR, respectively. Line 2R is inclined by 30 degrees clockwise with respect to the Y-axis, and line 2L is inclined by 30 degrees counterclockwise with respect to the Y-axis. Line 2SR is inclined by 45 degrees counterclockwise with respect to the Y-axis, and line 2SL is inclined by 45 degrees clockwise with respect to the Y-axis.

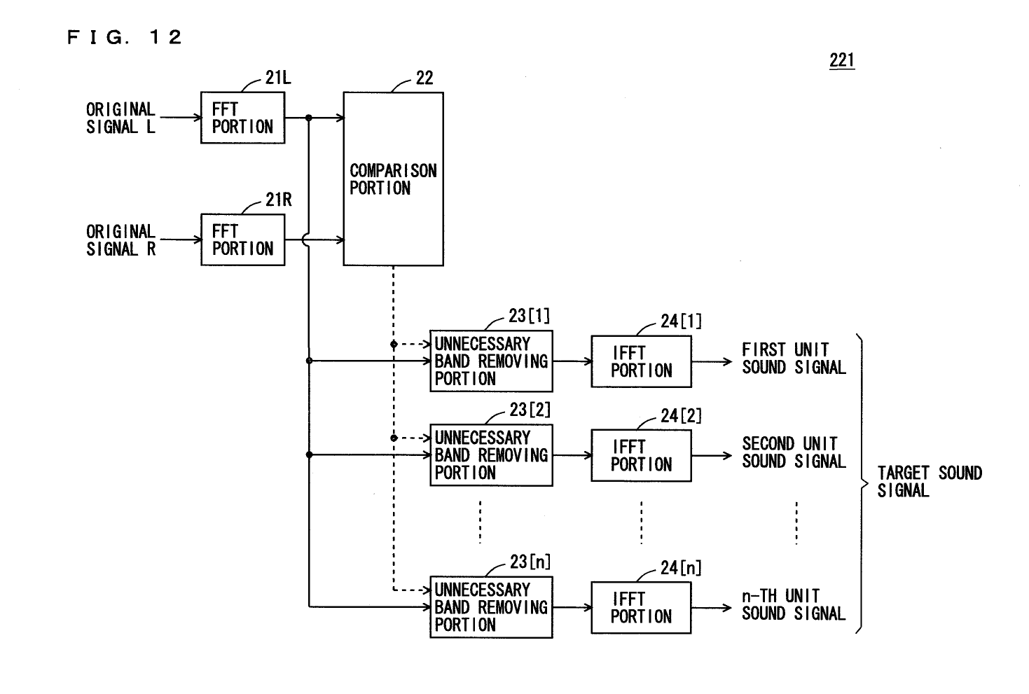

FIG. 11 illustrates areas in the two-dimensional plane. The XY coordinate plane is divided into six areas, namely, 3C, 3L, 3SL, 3B, 3SR, and 3R bounded by the X-axis, the Y-axis, and lines 2R, 2L, 2SL, and 2SR. Area 3C is a partial area of the first and second quadrants of the XY coordinate plane that is sandwiched between lines 2R and 2L. Area 3L is a partial area of the second quadrant of the XY coordinate plane that is sandwiched between line 2L and the X-axis. Area 3SL is a partial area of the third quadrant of the XY coordinate plane that is sandwiched between the X-axis and line 2SL. Area 3B is a partial area of the third and fourth quadrants of the XY coordinate plane that is sandwiched between lines 2SL and 2SR. Area 3SR is a partial area of the fourth quadrant of the XY coordinate plane that is sandwiched between line 2SR and the X-axis. Area 3R is a partial area of the first quadrant of the XY coordinate plane that is sandwiched between the X-axis and line 2R.

Left directional microphone 1L converts its collected sound into an electrical signal and outputs a sound signal representing the sound. Right directional microphone 1R converts its collected sound into an electrical signal and outputs a sound signal representing the sound. These sound signals are analog signals. The sound signals output by left directional microphone 1L and right directional microphone 1R are converted into digital signals by a not-shown A/D (analog/digital) converter. The sampling frequency for converting an analog signal into a digital signal in the A/D converter is 48 kHz (kilohertz) here. It is noted that a non-directional microphone having no directivity may be used in place of left directional microphone 1L and right directional microphone 1R.

Here, it is assumed that left directional microphone 1L is associated with a left channel and right directional microphone 1R is associated with a right channel. Digital signals obtained by digitizing the sound signals of left directional microphone 1L and right directional microphone 1R are referred to as an original signal L and an original signal R, respectively. Original signals L and R are signals in the time domain.

Returning to FIG. 9, sound source separation portion 221 generates and outputs a unit sound signal for each sound source. For example, sound source separation portion 221 generates each unit sound signal by enhancing a signal component of a sound coming from a particular direction by directivity control, based on the sound signals respectively output from left directional microphone 1L and right directional microphone 1R. Sound source separation portion 221 generates each unit sound signal based on original signals L and R which are sound signals output by left directional microphone 1L and right directional microphone 1R as described below.

FIG. 12 is a block diagram showing an example of a configuration of the sound source separation portion in detail. Sound source separation portion 221 includes FFT portions 21L and 21R, a comparison portion 22, unnecessary band removing portions 23[1]-23[n], and IFFT portions 24[1]-24[n].

FFT portions 21L and 21R calculate frequency spectra of the left and right channels, which are signals in the frequency domain, by performing discrete Fourier transform on original signals L and R, which are time-domain signals. As a result of the discrete Fourier transform, the frequency bands of original signals L and R are subdivided into a plurality of frequency bands. Frequency sampling intervals in the discrete Fourier transform in FFT portions 21L and 21R are set such that each of the subdivided bands includes a sound signal component from only one sound source. With this setting, a sound signal component of each sound source can be separated and extracted from a signal including sound signals of a plurality of sound sources. Each subdivided frequency band is referred to as a subdivided band hereinafter.

Comparison portion 22 calculates, for each subdivided band, the phases of signal components of the left and right channels in the subdivided band, based on data representing the results of discrete Fourier transform by FFT portions 21L and 21R. Then, focusing on each individual subdivided band, comparison portion 22 determines which direction the main component of the signal in that subdivided band comes from, based on the phase difference between the left and right channels in the subdivided band that is focused on. This determination is made for all the subdivided bands. Then, the subdivided band in which the main component of the signal is determined to come from the i-th direction (where i is a positive integer) is set as the i-th necessary band. If there exist a plurality of subdivided bands in which the main component of the signal is determined to come from the i-th direction, a composite band of the plurality of subdivided bands is set as the i-th necessary band. This setting process is performed with i=1, 2, . . . , (n−1), n. As a result, the first to n-th necessary bands respectively corresponding to the first to n-th directions are set.

Unnecessary band removing portion 23[1] regards a subdivided band that does not belong to the first necessary band, as an unnecessary band, and decreases by a certain amount the signal level of the unnecessary band in the frequency spectrum calculated by FFT portion 21L. For example, the signal level of the unnecessary band is decreased by 12 dB (decibels) in terms of voltage ratio. In unnecessary band removing portion 23[1], the signal level of the first necessary band is not decreased. IFFT portion 24[1] uses inverse discrete Fourier transform to transform the frequency spectrum after the signal level decrease by unnecessary band removing portion 23[1], into a time-domain signal, and outputs the resultant signal as a first unit sound signal. Here, the signal level represents power of the signal that is focused on. However, the signal level may be understood as the amplitude of the signal that is focused on.

Unnecessary band removing portions 23[2]-23[n] and IFFT portions 24[2]-24[n] operate similarly. Specifically, for example, unnecessary band removing portion 23[2] regards a subdivided band that does not belong to the second necessary band, as an unnecessary band, and decreases by a certain amount the signal level of the unnecessary band in the frequency spectrum calculated by FFT portion 21L. For example, the signal level of the unnecessary band is decreased by 12 dB in terms of voltage ratio. In unnecessary band removing portion 23[2], the signal level of the second necessary band is not decreased. IFFT portion 24[2] uses inverse discrete Fourier transform to transform the frequency spectrum after the signal level decrease by unnecessary band removing portion 23[2], into a time-domain signal, and outputs the resultant signal as a second unit sound signal.

The i-th unit sound signal obtained in this manner is a sound signal only representing a sound from the i-th sound source, among the sounds accepted by sound accepting portion 155 (here, an error is ignored). Here, i is a positive integer, i.e. 1, 2, . . . (n−1) or n. The first to n-th unit sound signals are output as sound signals of the first to n-th sound sources, respectively, from sound source separation portion 221 to direction separation processing portion 222.

The i-th direction (the direction of the i-th sound source) and the directions related thereto refer to the directions having a reference at origin O (see FIG. 10). The first to n-th directions each are a direction from a sound source that is focused on, toward origin O. The first to n-th directions differ from each other. The i-th direction may be a direction extending over a certain range.

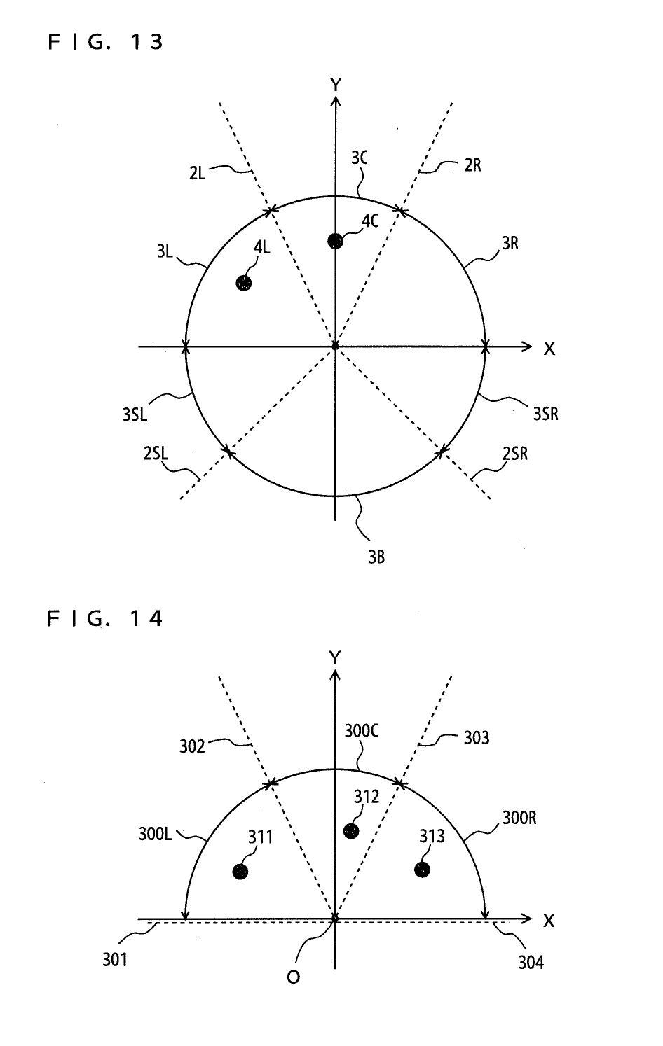

FIG. 13 illustrates areas in a two-dimensional plane and directions of sound sources. For example, when a sound source 4C as a first sound source is located in an area 3C and a sound source 4L as a second sound source is located in an area 3L, the direction from sound source 4C toward origin O is the first direction and the direction from sound source 4L toward origin O is the second direction. In this case, sound source separation portion 221 extracts sound signals representing sounds from sound sources 4C and 4L separately as first and second unit sound signals.

Although sound source separation portion 221 generates each unit sound signal by decreasing the signal level of an unnecessary band, each unit sound signal may be generated by increasing the signal level of a necessary band, or by decreasing the signal level of an unnecessary band and increasing the signal level of a necessary band. Alternatively, the similar process as above may be performed using the power difference between the left and right channels, in place of the phase difference between the left and right channels. Furthermore, although sound source separation portion 221 includes n pairs of unnecessary band removing portions and IFFT portions for generating n unit sound signals, it may include less than n pairs of unnecessary band removing portions and IFFT portions if a plurality of unit sound signals are allocated to a pair of an unnecessary band removing portion and an IFFT portion and the pair of an unnecessary band removing portion and an IFFT portion is used in a time division manner. Furthermore, although sound source separation portion 221 generates each unit sound signal based on detection signals of the two, left directional microphone 1L and right directional microphone 1R, it may generate each unit sound signal based on detection signals of three or more microphones arranged at different locations.

Furthermore, in place of using directivity control as executed in sound separation portion 221, a stereo microphone that alone can collect sounds in stereo may be used to collect sounds from sound sources individually. In this manner, a plurality of unit sound signals separated from each other may be obtained directly. Alternatively, n directional microphones (microphones having directivity) may be used to collect sounds from sound sources individually, where the directions in which the first to n-th microphones have high sensitivity are oriented in the first to n-th directions corresponding to the first to n-th sound sources. In this manner, the first to n-th unit source signals that are separated from each other can be obtained directly.

When the locations of the first to n-th sound sources are known in advance, the first to n-th cordless microphones may be arranged at the locations of the first to n-th sound sources such that the i-th cordless microphone collects a sound of the i-th sound source (where i=1, 2, . . . (n−1), n). In this manner, the first to n-th cordless microphones can directly obtain the first to n-th unit sound signals separated from each other, corresponding to the first to n-th sound sources.

Furthermore, Independent Component Analysis may be used to generate the first to n-th unit sound signals from detection signals of a plurality of microphones (for example, left directional microphone 1L and right directional microphone 1R). In Independent Component Analysis, assuming that a plurality of sound signals from the same sound source do not exist at the same time, a sound signal from each sound source is separately collected using independence of sound source.

Returning to FIG. 9, the sound signal output by sound source separation portion 221 is a target sound signal. The target sound signal is a sound signal including a first unit sound signal representing a sound from the first sound source, a second unit sound signal representing a sound from the second sound source, . . . , the (n−1)th unit sound signal representing a sound from the (n−1)th sound source, and the n-th unit sound signal representing a sound from the n-th sound source (where n is an integer equal to or larger than two). The first to n-th unit sound signals are output as sound signals of the first to n-th sound sources, respectively, from sound source separation portion 221 to direction separation processing portion 222. The i-th unit sound signal is a sound signal coming from the i-th direction toward IC recorder 100 (more specifically, origin O of IC recorder 100) (where i is an integer).

Sound source positional information representing the above-noted first to n-th directions or sound source positional information representing the presence locations of the first to n-th sound sources is added to the first to n-th unit sound signals output from sound source separation portion 221. This sound source positional information is used in direction separation processing portion 222.

The i-th direction representing the direction of the i-th sound source is determined by the above-noted phase difference, the direction of directivity of the above-noted stereo microphone, or the direction of directivity of the above-noted directional microphone, corresponding to the i-th sound source (where i=1, 2, . . . , (n−1), n). The presence location of the i-th sound source is determined by the location where the above-noted cordless microphone corresponding to the i-th sound source is arranged (where i=1, 2, . . . , (n−1), n).

Direction separation processing portion 222 receives the first to n-th unit sound signals (target sound signal) from sound source separation portion 221, as well as the sound source positional information representing the first to n-th directions or the sound source positional information representing the presence locations of the first to n-th sound sources, respectively added to the first to n-th unit sound signals. Direction separation processing portion 222 separates and extracts the left direction signal, the central direction signal, and the right direction signal from the target sound signal based on the sound source positional information.

Direction separation processing portion 222 includes the first unit sound signal in one of the left direction signal, the central direction signal, and the right direction signal, based on the sound source positional information. Specifically, if the incoming direction of the first unit sound signal, that is, the first direction corresponding to the first unit sound signal is the direction from any location in area 300L toward origin O, the first unit sound signal is included in the left direction signal. If the first direction is the direction from any location in area 300C toward origin O, the first unit sound signal is included in the central direction signal. If the first direction is the direction from any location in area 300R toward origin O, the first unit sound signal is included in the right direction signal. A similar process is also performed for the second to n-th unit sound signals. As a result, each unit sound signal is included in one of the left direction signal, the central direction signal, and the right direction signal.

FIG. 14 illustrates an example of sound sources and their directions. In this example, n=3, and a sound source 311 as the first sound source, a sound source 312 as the second sound source, and a sound source 313 as the third sound source are located in areas 300L, 300C, and 300R, respectively. In this case, the left direction signal, the central direction signal, and the right direction signal are the first, second, and third unit sound signals, respectively. This is applicable to a case where a plurality of sound sources are present in one area. For example, if n=6, and the first, second, and third sound sources are located in area 300L, the fourth and fifth sound sources are located in area 300C, and the sixth sound source is located in area 300R, then the left direction signal is a composite signal of the first, second, and third unit sound signals, the central direction signal is a composite signal of the fourth and fifth unit sound signals, and the right direction signal is the sixth unit sound signal.

The left direction signal is obtained by separating and extracting from the target sound signal a unit sound signal from a sound source located in area 300L. In other words, the left direction signal is a sound signal coming from any location in area 300L. This is applicable to the central direction signal and the right direction signal. In other words, the direction from any location in area 300L toward origin O is the left direction, the direction from any location in area 300C toward origin O is the central direction, and the direction from any location in area 300R toward origin O is the right direction.

In the present embodiment, the left direction signal, the central direction signal, and the right direction signal are generated through generation of unit sound signals. However, the left direction signal, the central direction signal, and the right direction signal may be extracted not through generation of unit sound signals but directly from a recorded sound signal as an input sound signal, that is, from the detection signals of a plurality of microphones, by directivity control. Of the target sound signal or the recorded sound signal, a signal component whose sound incoming direction is the left direction is the left direction signal (this is applicable to the central direction signal and the right direction signal).

As described above, IC recorder 100 in the present embodiment accepts designation of one of three directions, namely, left, right, and central directions when one of up button 108A, right button 108D, and left button 108C of cross key 107C is pressed. Then, the one of left direction image 400A, right direction image 400C, and central direction image 400B that corresponds to the designated direction is displayed. Then, IC recorder 100 generates a sound in which the sound emitted from the designated direction is enhanced as compared with sounds emitted from other directions, and then outputs the generated sound to speaker 123 or an earphone connected to headphone terminal 125. When designation of one of the left, right, and central directions is accepted, the designated direction is displayed, and in addition, a sound in which the sound emitted from the designated direction is enhanced as compared with sounds from other directions is output. Therefore, it is possible to simplify the operation for producing a sound having an enhanced sound coming from one of the left, right, and central directions.

Left direction image 400A, right direction image 400C, and central direction image 400B are each an image in which three images each depicting a persons are arranged at three locations of left, right, and center, respectively. Left direction image 400A is an image in which the image on the left is displayed in a size larger than the other images. Right direction image 400C is an image in which the image on the right is displayed in a size larger than the other images. Central direction image 400B is an image in which the image in the center is displayed in a size larger than the other images. Therefore, the user can visually confirm the designated direction.

In addition, in right direction image 400C, left direction image 400A, and central direction image 400B, three images on the left and right and in the center are arranged at the relative positions similar to the relative positions of right button 108D, left button 108C, and up button 108A of cross key 107C. Therefore, the user can intuitively grasp the respective directions corresponding to right button 108D, left button 108C, and up button 108A of cross key 107C.

Although directivity of sounds is controlled during reproduction in the present embodiment, directivity of sounds may be changed during recording. A method of changing directivity of sounds is not limited to the method described in the present embodiment and may employ, for example, the technique disclosed in Japanese Patent Laying-Open No. 2005-124090.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A sound control apparatus comprising:
a direction accepting portion to accept designation of any one of a plurality of predetermined directions;
a display control portion to allow a display portion to output a plurality of direction marks respectively indicating said plurality of directions;
a plurality of microphones arranged at a distance away from each other; and
a directivity control portion to control directivity of sounds respectively obtained by said plurality of microphones, based on the direction accepted by said direction accepting portion,
wherein said display control portion allows said display portion to display a direction mark corresponding to the direction accepted by said direction accepting portion in such a manner as to be enhanced as compared with any other direction mark.

2. The sound control apparatus according to claim 1, further comprising an operation key including a plurality of switches to which said plurality of directions are respectively allocated, wherein
said direction accepting portion accepts designation of a direction allocated in advance for a switch operated among said plurality of switches to select any given direction from among said plurality of directions, and
said display control portion allows said display portion to output said plurality of direction marks in such a manner that said plurality of direction marks have a relative positional relation similar to a relative positional relation of said plurality of switches.

3. The sound control apparatus according to claim 2, wherein
said display portion is a display, and
said plurality of direction marks are characters each depicting an object, and are respectively arranged in a left part, a right part, and an upper part with respect to the center of the display.

4. A sound control method executed in a sound control apparatus including a plurality of microphones arranged at a distance away from each other and a display portion, comprising:
an accepting step of accepting designation of any one of a plurality of predetermined directions;
a display control step of allowing said display portion to output a plurality of direction marks respectively indicating said plurality of directions; and
a directivity control step of controlling directivity of sounds respectively obtained by said plurality of microphones, based on the direction accepted in said accepting step,
wherein said display control step includes a step of allowing said display portion to display a direction mark corresponding to the direction accepted in said accepting step in such a manner as to be enhanced as compared with any other direction mark.

5. The sound control method according to claim 4, wherein
said sound control apparatus further includes an operation key including a plurality of switches to which said plurality of directions are respectively allocated,
said accepting step includes a step of accepting designation of a direction allocated in advance for a switch operated among said plurality of switches to select any given direction from among said plurality of directions, and
said display control step includes a step of allowing said display portion to output said plurality of direction marks in such a manner that said plurality of direction marks have a relative positional relation similar to a relative positional relation of said plurality of switches.

6. The sound control method according to claim 5, wherein
said display portion is a display,
said plurality of direction marks are characters each depicting an object, and
said display control step includes a step of displaying said plurality of direction marks respectively arranged in a left part, a right part, and an upper part with respect to the center of the display.

7. A non-transitory computer-readable recording medium encoded with a sound control program, the sound control program causing a computer that controls a sound control apparatus including a plurality of microphones arranged at a distance away from each other and a display portion to execute:
an accepting step of accepting designation of any one of a plurality of predetermined directions;
a display control step of allowing said display portion to output a plurality of direction marks respectively indicating said plurality of directions; and
a directivity control step of controlling directivity of sounds respectively obtained by said plurality of microphones, based on the direction accepted in said accepting step,
wherein said display control step includes a step of allowing said display portion to display a direction mark corresponding to the direction accepted in said accepting step in such a manner as to be enhanced as compared with any other direction mark.

8. The non-transitory computer-readable recording medium encoded with the sound control program according to claim 7, wherein
said sound control apparatus further includes an operation key including a plurality of switches to which said plurality of directions are respectively allocated,
said accepting step includes a step of accepting designation of a direction allocated in advance for a switch operated among said plurality of switches to select any given direction from among said plurality of directions, and
said display control step includes a step of allowing said display portion to output said plurality of direction marks in such a manner that said plurality of direction marks have a relative positional relation similar to a relative positional relation of said plurality of switches.

9. The non-transitory computer-readable recording medium encoded with the sound control program according to claim 8, wherein
said display portion is a display,
said plurality of direction marks are characters each depicting an object, and
said display control step includes a step of displaying said plurality of direction marks respectively arranged in a left part, a right part, and an upper part with respect to the center of the display.
